(19) United States
(12) Patent Application Publication
(10) Pub. No.: US 2004/0094383 A1
(43) Pub. Date: May 20, 2004

(54) Multi-plate clutch and rotational speed detecting sensor attaching structure

(75) Inventors: Yoshio Kinoshita, Shizuoka-ken (JP); Hirofumi Nakagomi, Fukuroi-shi (JP); Hiroshi Yabe, Kakegawa-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K. K.

(21) Appl. No.: 10/712,099

(22) Filed: Nov. 14, 2003

(30) Foreign Application Priority Data
Nov. 20, 2002 (JP) 2002-336488

(51) Int. Cl. F16D 25/0638

(52) U.S. Cl. 192/85 AA

(57) ABSTRACT

The present invention provides a multi-plate clutch in which friction engagement elements are disposed within a clutch case so that a power is transmitted by an applying tightening load to the friction engagement elements, wherein a tone wheel is provided on an outer periphery of the clutch case. Further, the present invention provides a rotational speed detection sensor attaching structure for attaching a rotational speed detection sensor for detecting a rotational speed of a multi-plate clutch having a clutch case provided at its outer periphery with a substantially cylindrical portion, wherein the cylindrical portion is provided with an oil port opened to the outer periphery and adapted to discharge lubricating oil and the rotational speed detection sensor is attached to a position opposed to the oil port so that the rotational speed is detected by detecting a position of the oil port.

### BACKGROUND OF THE INVENTION

1. Field of the Invention

The present invention relates to a multi-plate clutch used in an automatic transmission of a motor vehicle and the like. More specifically, the present invention relates to a structure of a clutch case of a multi-plate clutch and a rotational speed detecting sensor attaching structure.

2. Related Background Art

In the past, in order to detect a rotational speed of a clutch case (drum) of a multi-plate clutch used in an automatic transmission and the like, various techniques have been proposed. For example, a technique in which a rotational speed sensor is opposed to pulse teeth provided on an outer peripheral surface of a closed end of a clutch case and so that, when the clutch case is rotated, pulse signals generated by the pulse teeth are read by the rotational speed sensor, thereby detecting a rotational speed of the clutch case has been proposed. For example, refer to Japanese Patent Application Laid-open No. 2001-90817.

Further, a technique in which pulse signals generated by unevenness of an outer peripheral surface of a clutch case is read by a rotational speed sensor provided in the vicinity of an outer peripheral surface of a closed end of the clutch case, thereby detecting a rotational speed of the clutch case. Fir example, refer to Japanese Patent Laid-open No. 10-339368.

The detected rotational speed of the clutch case is inputted to a control circuit as an electrical signal to be used for controlling a transmission timing of a transmission. For example, refer to Japanese Utility Model Application Laid-open No. 51-107583.

Prior art information relating to the present invention can further be derived from Japanese Patent Application Laid-open No. 6-17840.

The above-mentioned conventional detecting apparatuses and structures have the following disadvantages:

(1) Since the structure detecting the rotational speed utilizes the pulse teeth provided on the outer periphery of the clutch case or the unevenness provided on the outer periphery, a predetermined thickness of the clutch case is required for maintaining desired rigidity, with the result that it is difficult to make the entire clutch case lighter.

(2) Since the unevenness configuration is required to detect the rotational speed, the outer periphery of the clutch case cannot be formed as a cylindrical shape which has a simple construction. Thus, it is difficult to make the clutch case lighter and it is also difficult to use the clutch case as a rotatable drum for a brake band.

### SUMMARY OF THE INVENTION

Therefore, an object of the present invention is to provide a multi-plate clutch in which an entire clutch case can be made lighter while maintaining desired strength of an opening portion of the clutch case.

Further, another object of the present invention is to provide a rotational speed detection sensor attaching structure in which a rotational speed of a multi-plate clutch can be detected without changing a structure of the multi-plate clutch, in a multi-plate clutch having a substantially cylindrical portion on an outer peripheral surface of a clutch case, where a spline unevenness configuration is not formed.

To achieve one of the above objects, the present invention provides a multi-plate clutch in which friction engagement elements are disposed within a clutch case and a power is transmitted by applying fastening load to the friction engagement elements and wherein a tone wheel is provided on an outer periphery of the clutch case.

Further, in order to achieve the other object of the present invention, the present invention provide a rotational speed detection sensor attaching structure in which the sensor serves to detect a rotational speed of a multi-plate clutch having a clutch case including a substantially cylindrical portion on an outer periphery and wherein the cylindrical portion is provided with an oil port opened to the outer periphery and adapted to discharge lubricating oil and the rotational speed detection sensor is attached to a position opposed to the oil port so that the rotational speed is detected by detecting a position of the oil port.

By providing the tone wheel on the outer periphery of the clutch case, since it is not required that any pulse teeth or unevenness configuration is not formed on the outer periphery of the clutch case, the entire clutch case can be made thinner and the construction can be simplified.

By using the oil port opened to the outer periphery of the clutch case to detect the rotational speed, the outer periphery of the clutch case can be maintained as the cylindrical form. That is to say, the rotational speed can be detected without changing the configuration of the clutch case.

### BRIEF DESCRIPTION OF THE DRAWINGS

FIG. 1 is a front view of a multi-plate clutch to which the present invention is applied, looked at from an open end side;

FIG. 2 is an axial sectional view of the multi-plate clutch of FIG. 1;

FIG. 3 is a front view of a tone wheel according to a first embodiment of the present invention;

FIG. 4 is a side view of the tone wheel of FIG. 1;

FIG. 5 is a front view of a tone wheel according to a second embodiment of the present invention;

FIG. 6 is a development view, in partial section, of the tone wheel of FIG. 5;

FIG. 7 is an axial sectional view showing main parts, looked at from the line A-A in FIG. 6;

FIG. 8 is a front view of a tone wheel according to a third embodiment of the present invention;

FIG. 9 is a development view, in partial section, of the tone wheel of FIG. 8;

FIG. 10 is an axial sectional view showing main parts, looked at from the line B-B in FIG. 9;

FIG. 11 is a front view of a tone wheel according to a fourth embodiment of the present invention;

FIG. 12 is a development view, in partial section, of the tone wheel of FIG. 11;

FIG. 13 is an axial sectional view showing main parts, looked at from the line C-C in FIG. 12;

FIG. 14 is a front view of a clutch case according to a fifth embodiment of the present invention; and

FIG. 15 is an axial sectional view of FIG. 14.

### DESCRIPTION OF THE PREFERRED EMBODIMENTS

Now, embodiments of the present invention will be fully explained with reference to the accompanying drawings. Incidentally, in the drawings, the same elements are designated by the same reference numerals. Further, it should be noted that embodiments which will be described later are merely used to explain the present invention as examples and do not limit the present invention.

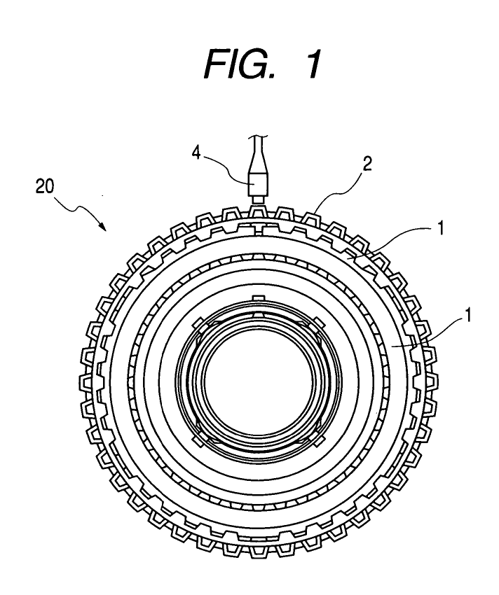

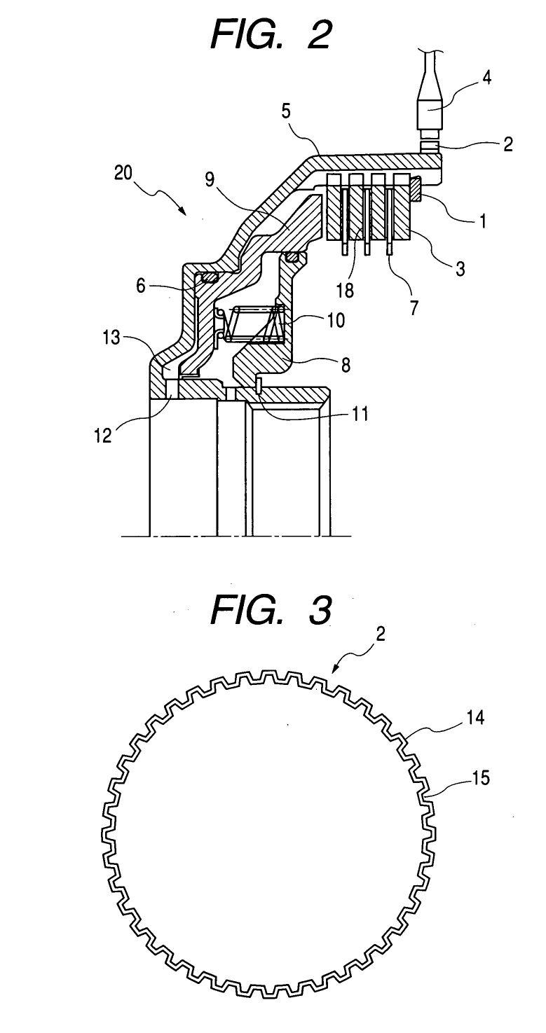

FIGS. 1 and 2 show a multi-plate clutch to which various embodiments of the present invention are applied. FIG. 1 is a front view of the multi-plate clutch, looked at from an opening end side and FIG. 2 is an axial sectional view thereof. Incidentally, FIGS. 1 and 2 show an example in which a tone wheel according to a first embodiment of the present invention is attached.

As shown in FIGS. 1 and 2, a multi-plate clutch 20 comprises a clutch case 5 opened at its axial one end and having a substantially cylindrical outer periphery, and a plurality of annular separator plates 3 are axially engaged by a spline provided on an inner periphery of the clutch case 5.

A plurality of annular friction plates 7 alternately disposed between the separator plates 3 and inner peripheral teeth of the friction plates are axially engaged by a spline (not shown) provided on an outer periphery of a hub (not shown). Each friction plate 7 to one surface or both surfaces of which friction material(s) are secured is axially secured at an opening end of the clutch case 5 by means of a snap ring 1. Accordingly, moving ranges of the friction plates 7 and the separator plates 3 as friction engagement elements and a piston 9 which will be described later are limited.

On the other hand, the piston 9 is provided at the opening end of the clutch case 5 so that, when oil is poured into an oil chamber 13 through an oil port 12 to generate pressure in the oil chamber, the piston is shifted in an axial direction, with the result that the friction plates 3 are engaged by the separator plates 3 frictionally. Incidentally, an O-ring 6 as a seal member is provided on a sliding surface of the piston 9.

The hub (not shown) is provided with a plurality of lubricating oil supplying ports (not shown) passing through the hub in a radial direction and serving to cool the friction plates 7, separator plates 3 and friction materials 18. The lubricating oil is discharged outside through an oil port 16 which will be described in connection with a fifth embodiment of the present invention.

A canceller 8 is provided at an opening end side of the piston 9 in the clutch case 5. The canceller 8 is secured an inner peripheral portion of the clutch case 5 by a stopper 11 and serves to limit an axial shifting movement of the clutch case 5 toward the opening end side. A spring 10 interposed between the piston 9 and the canceller serve to bias the piston 9 toward the opening end side of the clutch case 5.

The oil is supplied to the oil chamber 13. When the oil pressure in the oil chamber 13 is increased, the piston 9 overcomes a biasing force of the spring 10 of the canceller 8 and shift to a right direction in FIG. 2, with the result that the friction plates 7 to which the friction materials are secured are engaged by the separator plates 3 frictionally. As a result, the multi-plate clutch 20 can transmit a power.

When the oil pressure in the oil chamber 13 is released, since the piston 9 is shifted toward a closed end of the clutch case 5 by the biasing force of the spring 10, engagement of the friction engagement elements is released, thereby releasing the power transmission of the multi-plate clutch 20.

As shown in FIG. 1, a tone wheel 2 is fitted onto the outer periphery of the clutch case 5 in the vicinity of the opening end thereof. A rotational speed detection sensor 4 for detecting a rotational speed of the clutch case 5 is disposed radially outwardly of the tone wheel 2 in the vicinity of the tone wheel.

(First Embodiment)

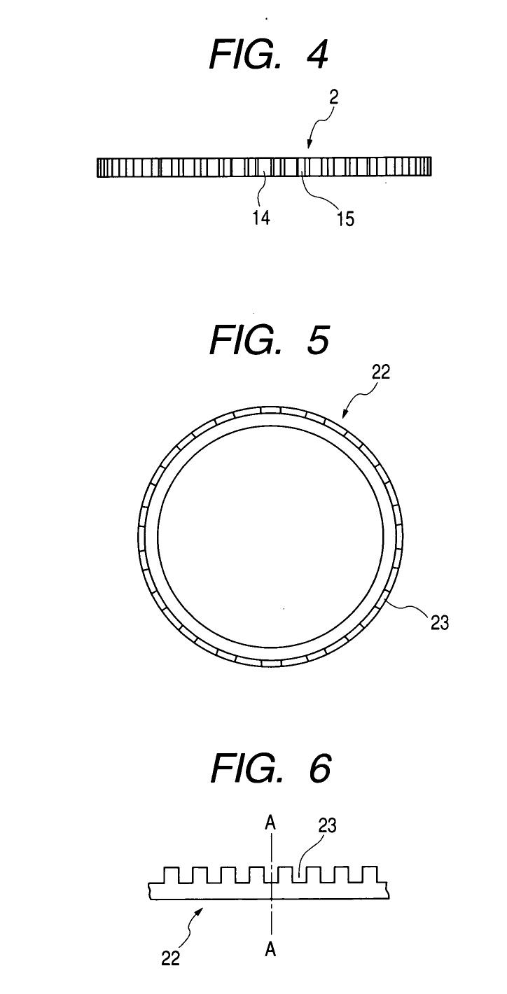

FIG. 3 is a front view of the tone wheel according to a first embodiment of the present invention and FIG. 4 is a side view of the tone wheel 2. As can be seen from FIG. 3, in the tone wheel 2, unevenness (protrusions and recesses) is provided on a substantially cylindrical annular member in a radial direction. That is to say, the protrusions 14 and the recesses 15 are alternately disposed continuously. When the clutch case 5 is rotated, the protrusions 14 and the recesses are alternately passed through a position opposed to the rotational speed detection sensor 4. With this arrangement, when the rotational speed detection sensor 4 detects the recess 15, the rotational speed detection sensor 4 generates a pulse signal, thereby detecting the rotational speed of the clutch case 5.

(Second Embodiment)

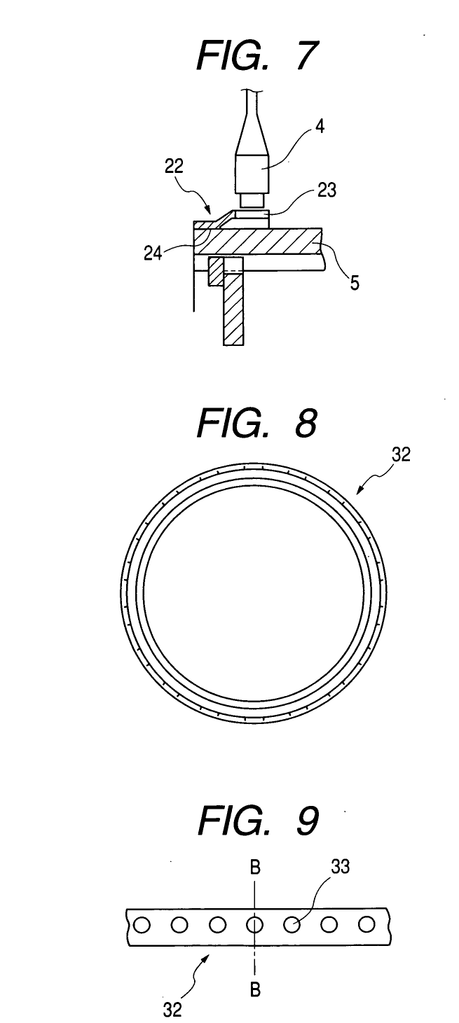

FIG. 5 is a front view of a tone wheel 22 according to a second embodiment of the present invention and FIG. 6 is a development view, in partial section, of the tone wheel 22 and FIG. 7 is an axial sectional view showing main parts, taken along the line A-A in FIG. 6. Also in this embodiment, the main parts of the multi-plate clutch are similar to these shown in FIGS. 1 and 2.

The tone wheel 22 according to the second embodiment is provided with slits 23 passing through a substantially cylindrical annular member radially. The slits 23 are opened to an axial one end of the tone wheel 22. The slits 23 are disposed at predetermined pitches in a circumferential direction of the tone wheel 22. When the clutch case 5 is rotated, the slits 23 and areas between the slits 23 are alternately passed through a position opposed to the rotational speed detection sensor 4. With this arrangement, when the rotational speed detection sensor 4 detects the slit 23, the rotational speed detection sensor 4 generates a pulse signal, thereby detecting the rotational speed of the clutch case 5.

As shown in FIG. 7, the tone wheel 22 comprises a portion in which the slits 23 are formed, and a joint portion 24 for joining the tone wheel 22 to the clutch cases 5. The portion in which the slits 23 are formed is spaced apart from the outer peripheral surface of the clutch case 5 with a predetermined gap therebetween. In FIG. 7, the left end is the opening portion of the clutch case 5, and the joint portion 24 is contacted with the opening end portion of the clutch case 5. However, a reverse construction may be used. That is to say, the slits 23 may be disposed around the opening end portion. However, it is preferable to utilize the arrangement shown in FIG. 7 in the viewpoint of the fact that rigidity of the opening end portion is increased.

(Third Embodiment)

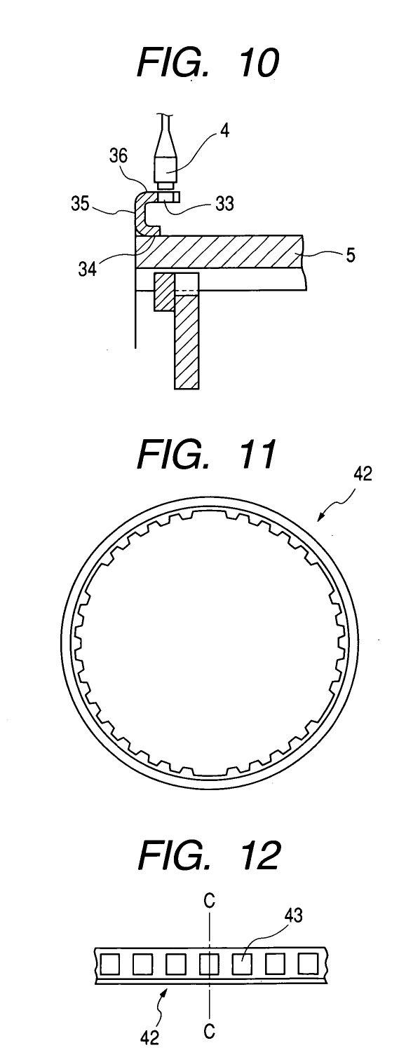

FIG. 8 is a front view of a tone wheel 32 according to a third embodiment of the present invention and FIG. 9 is a development view, in partial section, of the tone wheel 32 and FIG. 10 is an axial sectional view showing main parts, taken along the line B-B in FIG. 9. Also in this embodiment, the main parts of the multi-plate clutch are similar to these shown in FIGS. 1 and 2.

The tone wheel 32 according to the third embodiment is provided with holes 33 passing through a substantially cylindrical annular member radially. The holes 33 have a substantially cylindrical shape and are disposed at predetermined pitches in a circumferential direction of the tone wheel 32. When the clutch case 5 is rotated, the holes 33 and areas between the holes 33 are alternately passed through a position opposed to the rotational speed detection sensor 4. With this arrangement, when the rotational speed detection sensor 4 detects the hole 33, the rotational speed detection sensor 4 generates a pulse signal, thereby detecting the rotational speed of the clutch case 5.

As shown in FIG. 10, the tone wheel 32 comprises an outer cylindrical portion 36 in which the holes 33 are formed, an inner cylindrical portion 34 to be joined to the clutch case 5, and a disc portion 35 for integrally connecting the outer cylindrical portion 36 to the inner cylindrical portion 35. The outer cylindrical portion 36 in which the holes 33 are formed is spaced apart from the outer peripheral surface of the clutch case 5 with a predetermined gap therebetween. In FIG. 10, the left end is the opening portion of the clutch case 5, and the inner cylindrical portion 34 is contacted with the opening end portion of the clutch case 5. However, a reverse construction may be used. That is to say, outer cylindrical portion 36 may be disposed around the opening end portion. However, it is preferable to utilize the arrangement shown in FIG. 10 in the viewpoint of the fact that rigidity of the opening end portion is increased.

(Fourth Embodiment)

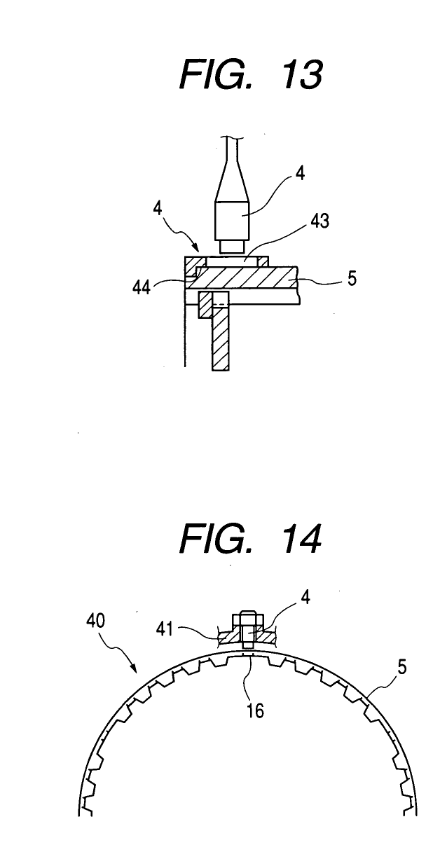

FIG. 11 is a front view of a tone wheel 42 according to a fourth embodiment of the present invention and FIG. 12 is a development view, in partial section, of the tone wheel 42 and FIG. 13 is an axial sectional view showing main parts, taken along the line C-C in FIG. 11. Also in this embodiment, the main parts of the multi-plate clutch are similar to these shown in FIGS. 1 and 2.

The tone wheel 42 according to the fourth embodiment is provided with holes 43 passing through a substantially cylindrical annular member radially. The holes 43 have a rectangular shape and are disposed at predetermined pitches in a circumferential direction of the tone wheel 42. When the clutch case 5 is rotated, the holes 43 and areas between the holes 43 are alternately passed through a position opposed to the rotational speed detection sensor 4. With this arrangement, when the rotational speed detection sensor 4 detects the hole 43, the rotational speed detection sensor 4 generates a pulse signal, thereby detecting the rotational speed of the clutch case 5.

As shown in FIG. 13, the tone wheel 42 comprises a cylindrical portion in which the holes 43 are formed, and a flange portion 44 to be joined to the axial end of the opening portion of the clutch case 5. In the fourth embodiment, the entire tone wheel abuts against the opening portion. Accordingly, this design is more effective to increase the rigidity of the opening portion of the clutch case 5.

Unlike to the first to third embodiments, in the tone wheel 42 according to the fourth embodiment, a depth of the recess or hole to be detected by the rotational speed detection sensor 4 merely corresponds to a thickness of the material of the tone wheel 42. With this arrangement, an advantage that the radial dimension of the entire apparatus is not increased is obtained.

In the above-mentioned tone wheels according to the first to fourth embodiments, a cylindrical material may be press-worked to form the unevenness, slits or holes or, after a plate-shaped material is press-worked to form the unevenness, slits or holes, the plate-shaped material may be rounded to form a cylinder and then both longitudinal edges of the cylinder may be joined together by welding, brazing, caulking or riveting.

Further, the joining of the tone wheel to the clutch case is performed by using welding, brazing, caulking or riveting. Incidentally, after a plate-shaped material is press-worked to form the unevenness, slits or holes, the plate-shaped material may be wrapped around the outer periphery of the clutch case to form a cylinder.

(Fifth Embodiment)

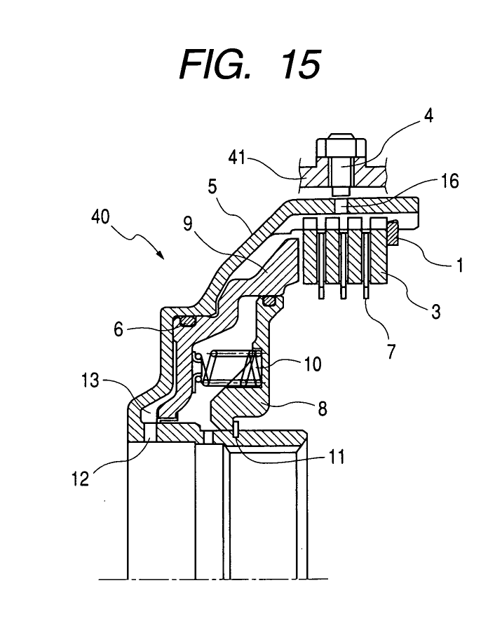

FIG. 14 is a front view of a clutch case according to a fifth embodiment of the present invention and FIG. 15 is an axial sectional view thereof. Since main parts of a multi-plate clutch 40 are similar to those shown in FIGS. 1 and 2, explanation thereof will be omitted. As shown in FIG. 14, an outer peripheral surface corresponding to a portion in which the friction engagement elements are arranged does not appear a spline configuration provided in the inner periphery of the clutch case but merely has a substantially cylindrical surface. Further, oil ports 16 passing through the clutch case from its outer peripheral surface to its inner peripheral surface are provided. The oil port 16 is a port serving to discharge the lubricating oil outside the clutch case 5 after the lubricating oil supplied from a hub (not shown) provided at the inner diameter side lubricates the friction engagement elements.

On the other hand, the rotational speed detection sensor 4 is attached to a case 41 of a transmission. When the clutch case 5 is rotated, the oil ports 16 and area between the oil ports 16 are alternately passed through a position opposed to the rotational speed detection sensor 4. With this arrangement, when the rotational speed detection sensor 4 detects the oil port 16, the rotational speed detection sensor 4 generates a pulse signal, thereby detecting the rotational speed of the clutch case 5.

The multi-plate clutch according to the present invention can be applied as both a wet type and a dry type. Further, as the rotational speed detection sensor, an electromagnetic (or magnet-electrical) sensor for detecting turbulence in magnetism within the sensor generated when a metallic body is moved toward and away from the sensor or a photo-electrical sensor for detecting light reflected from an object can be used.

However, in the present inventions, the electromagnetic sensor which is not influenced by the lubricating oil is suitable in consideration of the usage environment. For example, the conventional electromagnetic sensor disclosed in Japanese Patent Application Laid-open No. 2001-90817 and Japanese Utility Model Publication No. 6-4121 can be used.

Incidentally, the rotational speed detected by the rotational speed detection sensor 4 is inputted to a control circuit (not shown) as an electrical signal to be used for controlling a transmission timing of a transmission. Although the multi-plate clutch according to the present invention is attached the output side member, in addition to this, another rotational speed detection sensor is attached to an input side (for example, an engine) so that the timing is controlled by calculating a difference in two rotational speeds.

According to the above-mentioned invention, the following effects can be achieved.

If the thickness of the entire clutch case is reduced, the strength of the opening portion of the clutch case will be insufficient. However, by providing the tone wheel on the outer periphery of the clutch case, the clutch case is reinforced, thereby maintaining the desired strength. Further, since both the tone wheel and the clutch case can be press-worked, productivity is enhanced. Further, regardless of the number of the spline unevenness configurations provided on the clutch case, any number of pulsers (projections/recesses, holes, slits and the like) can be provided. By providing the tone wheel on the opening portion side, the opening portion is further reinforced, thereby enhancing the rigidity of the entire clutch case.

By utilizing the oil ports provided in the clutch case, without changing the style of the multi-plate clutch at all and without utilizing the spline unevenness on the outer peripheral surface of the clutch case, the rotational speed of the multi-plate clutch can be detected. Further, by forming the clutch case as the cylindrical shape, the clutch case can be made smaller and the clutch case can be used as a rotatable drum of a brake band.

What is claimed is:

1. A multi-plate clutch in which friction engagement elements are disposed within a clutch case so that a power is transmitted by an applying tightening load to said friction engagement elements, wherein:
a tone wheel is provided on an outer periphery of said clutch case.

2. A multi-plate clutch according to claim 1, wherein said tone wheel is provided in the vicinity of an opening portion of said clutch case.

3. A multi-plate clutch according to claim 1, wherein the outer periphery of said clutch case is substantially cylindrical.

4. A multi-plate clutch according to claim 2, wherein the outer periphery of said clutch case is substantially cylindrical.

5. A rotational speed detection sensor attaching structure for attaching a rotational speed detection sensor for detecting a rotational speed of a multi-plate clutch having a clutch case provided at its outer periphery with a substantially cylindrical portion, wherein:
said cylindrical portion is provided with an oil port opened to the outer periphery and adapted to discharge lubricating oil and said rotational speed detection sensor is attached to a position opposed to said oil port so that the rotational speed is detected by detecting a position of said oil port.
